(19) United States
(12) Patent Application Publication
(10) Pub. No.: US 2006/0171516 A1
(43) Pub. Date: Aug. 3, 2006

(54) Phone apparatus combined with keyboard

(76) Inventor: Mong-Tsang Tsai, Taipei City (TW)

Correspondence Address: HDSL, 4331 STEVENS BATTLE LANE, FAIRFAX, VA, 22033, US

(21) Appl. No.: 11/045,390

(22) Filed: Jan. 31, 2005

(51) Int. Cl. H04M 11/00; H04B 1/00

(52) U.S. Cl. 379/110.01; 379/93.05

(57) ABSTRACT

A phone apparatus combined with keyboard comprising a keyboard. A sound transmission device and a phone line socket are disposed on one side of the keyboard. The phone line socket is connected to a phone module in the keyboard, resulting in having both a computer operation and a communicated function to be convenient for the user and increase the working efficiency, thereby preventing the body injuries from operating the telephone and the keyboard at the same time.

### BACKGROUND OF THE INVENTION

1. Field of the Invention

The present invention relates to a phone apparatus combined with a keyboard, and more particularly, to an apparatus integrated the key operation with the dial phone, thereby providing for the computer operation and telephone communication.

2. Description of the Related Art

Computers and word processors are more and more prevalent in offices and homes. When using the keyboard to operate the computer, both hands are needed. When telephone is positioned beside the keyboard, and the telephone is ringing or the user wants to use it, the user needs to stop the computer operation, which is not convenient for the user, and may reduce the working efficiency or cause body injuries while operating the computer and using the telephone at the same time. Moreover, in order to reduce cost, the desk space is always limited. Conventional telephone usually occupies too much space on the desk.

### SUMMARY OF THE INVENTION

The present invention provides a phone apparatus combined with the keyboard, which integrates the key operation with the dial phone, thereby providing the integrated functional convenience and increasing the working efficiency.

The present invention also provides a phone apparatus combined with a keyboard, which prevents the body injuries such as the shoulder hurt, the neck hurt, and the vertebra hurt from the operation of the phone and the keyboard at the same time. According to one preferred embodiment of the present invention, a phone apparatus combined with keyboard is provided, comprising a keyboard. A sound transmission device and a phone line socket are disposed on one side of the keyboard. The phone line socket is connected to a phone module inside the keyboard. According to another embodiment of the present invention, a phone apparatus combined with keyboard is provided, comprising a phone apparatus. A sound transmission device and a phone line socket are disposed on one side of the phone apparatus. The phone line socket is connected to a phone module. The phone apparatus is used with a keyboard, thereby having both a computer operation and a telephone function.

The objectives of the present invention will become obvious to those of ordinary skill in the art after reading the following detailed description of the preferred embodiment.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view of the structure of the phone apparatus combined with keyboard according to a first embodiment of the present invention;

FIG. 1A shows the structure of the phone apparatus when the earphone/microphone apparatus is received in the keyboard according to a first embodiment of the present invention;

FIG. 1B shows the structure of the phone apparatus when the earphone/microphone apparatus is pulled from the keyboard according to a first embodiment of the present invention;

FIG. 2 is a perspective view of the structure of the phone apparatus combined with keyboard according to a second embodiment of the present invention;

FIG. 2A shows the structure of the phone apparatus when the earphone/microphone apparatus is received in the keyboard according to a second embodiment of the present invention;

FIG. 2B shows the structure of the phone apparatus when the earphone/microphone apparatus is pulled from the keyboard according to a second embodiment of the present invention;

FIG. 3 is a perspective view of the structure of the phone apparatus combined with keyboard according to a third embodiment of the present invention; and

FIG. 4 is a perspective view of the structure of the phone apparatus combined with keyboard according to a fourth embodiment of the present invention.

### DETAILED DESCRIPTION OF THE PREFERRED EMBODIMENTS

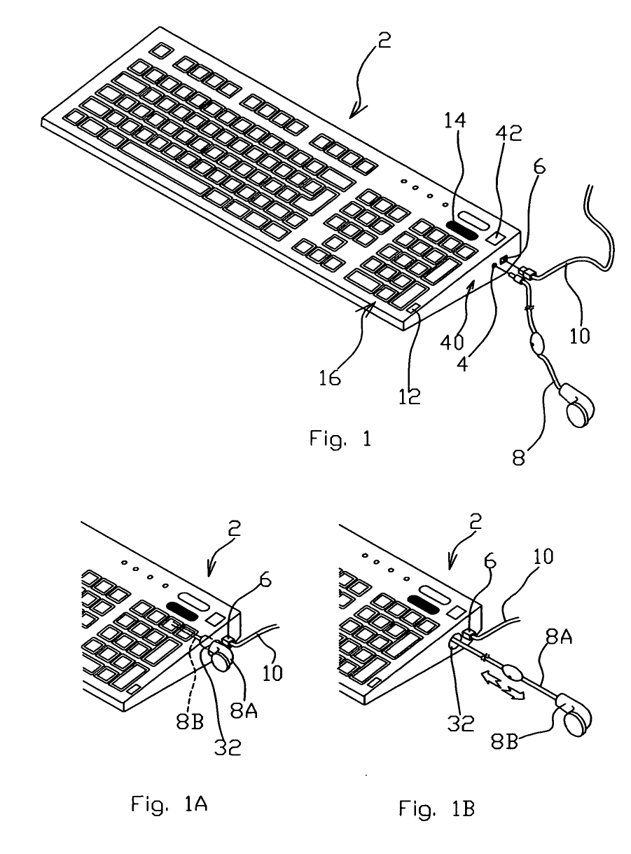

Referring to FIG. 1, the present invention provides a phone apparatus combined with keyboard, comprising a keyboard 2. A sound transmission device 40 and a phone line socket 6 are disposed on one side of the keyboard 2. The sound transmission device 40 comprises a sound transmission socket 4 for connecting with an earphone/microphone 8 to perform telephone communication. The phone line socket 6 is provided for connecting with a phone line 10 (or a network line). The phone line socket 6 is connected to a phone module (not shown) in the keyboard 2, thereby having the phone function. The keyboard 2 further comprises a speaker/microphone 12, a phone switching key 14, and a multifunction key module 16 disposed thereon. The keyboard 2 can be switched to perform a phone function via the phone switching key 14. The multifunction key module 16 comprises the numeral keys and a plurality of phone function keys such as transfer and hold.

The sound transmission device 40 further comprises a wireless transceiver 42 disposed on the keyboard 2. The wireless transceiver 42 can transmit and receive the sound by the wireless transmission way (for examples, the infrared ray or the blue teeth transmission, etc.). Therefore, the user can answer the phone by a wireless earphone/microphone (not shown). On the other hand, the earphone/microphone 8A can be positioned inside the keyboard 2, as shown in FIGS. 1A and 1B. A receiving hole 32 is disposed on one side of the keyboard 2. The earphone/microphone 8A has one end fixedly connected to the keyboard 2, and is retractable to be received in the receiving hole 32. When the phone is in use, the earphone portion 8B of earphone/microphone 8A can be pulled out. After using the phone, the earphone/microphone 8A is automatically retracted to have the earphone portion 8B rested in the receiving hole 32.

Accordingly, user can still operate the computer with both hands on the keyboard by pushing the phone switching key 14 and inserting the earphone/microphone 8 into the sound transmission socket 4 when using the phone. Also, it doesn't need to put down the telephone to do the computer operation while calling. Therefore, the user can answer the phone and operate the computer at the same time, thereby greatly increasing the working efficiency. When using the dialing function of the present invention, the user only needs to touch the phone switching key 14 to switch to a phone key module from a computer key module, resulting in having the numeral keys of the multifunction key module 16 to be the dialing keys. The calling then is easily made by touching the dialing keys via the phone line 10. The multifunction key module 16 also comprises the function keys such as transfer and hold keys. The user can use the present invention having the keyboard operation and the telephone function in order to reduce the space cost of office. In other case, if the user doesn't want to use the earphone/microphone 8, the speaker/microphone 12 on the keyboard 2 can be used to talk.

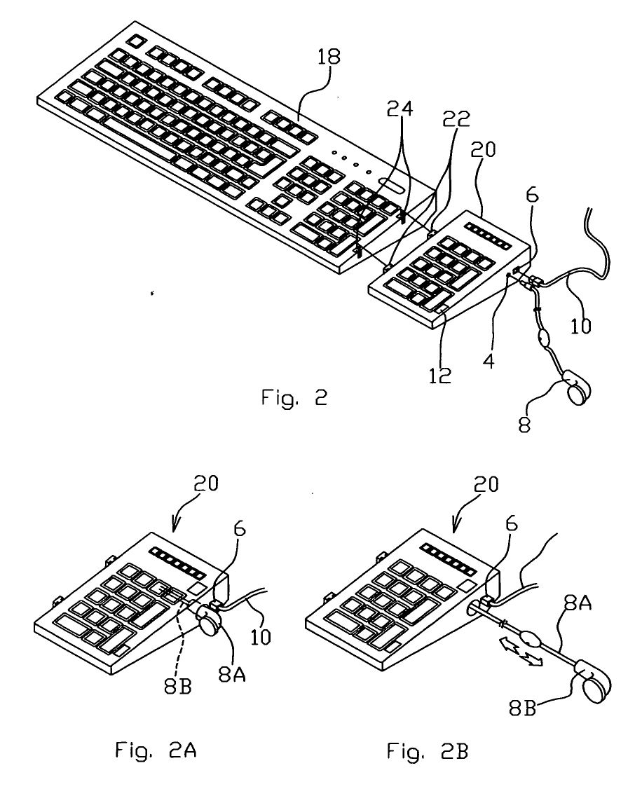

Next, referring to FIG. 2, a second embodiment of the present invention is shown. The keyboard 18 is separated from the phone apparatus 20. The phone apparatus 20 comprises two hook portions 22, and two slots 24 are formed on one corresponding side of the keyboard 18. Two hook portions 22 are engaged with two slots 24 to combine phone apparatus 20 and the keyboard 18. The user can easily replace the broken phone apparatus 20 or different type of phone apparatus 20. The phone apparatus 20 comprises a sound transmission device 40 and a phone line socket 6 disposed thereon. The phone line socket 6 is connected with the phone line 10 (or a network line), and one end of the phone line 10 is disposed in the phone module (not shown). The sound transmission device 40 comprises a sound transmission socket 4 for connecting with the earphone/microphone 8 to perform telephone communication. The phone apparatus 20 further comprises a speaker/microphone 12 and a multifunction key module 16 disposed thereon. The multifunction key module 16 comprises the numeral keys and a plurality of phone function keys such as transfer and hold, thereby connecting an external module phone apparatus 20 to provide the user more convenience.

In addition, the sound transmission device 40 further comprises a wireless transceiver 42 disposed thereon. The wireless transceiver 42 transmits and receives the sound by the wireless transmission way (for examples, the infrared ray or blue teeth transmission, etc.). The user answers the phone by the wireless earphone/microphone (not shown). Similarly, the earphone/microphone 8A can be positioned inside the keyboard 2, as shown in FIGS. 2A and 2B. A receiving hole 32 is disposed on one side of the keyboard 2. The earphone/microphone 8A has one end fixedly connected to the keyboard 2, and is retractable to be received in the receiving hole 32. When the phone is in use, the earphone portion 8B of earphone/microphone 8A can be pulled out. After using the phone, the earphone/microphone 8A is automatically retracted to have the earphone portion 8B rested in the receiving hole 32.

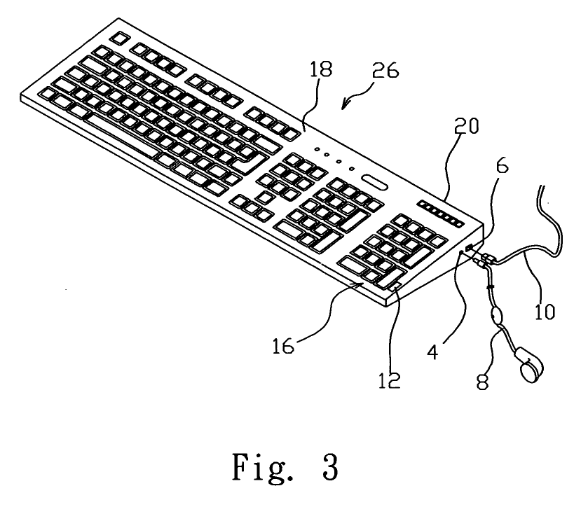

Referring to FIG. 3, a third embodiment of the present invention is shown, the keyboard 18 and the phone apparatus 20 are integrally formed to be an apparatus 26 combined with telephone and keyboard functions, but using individually keys.

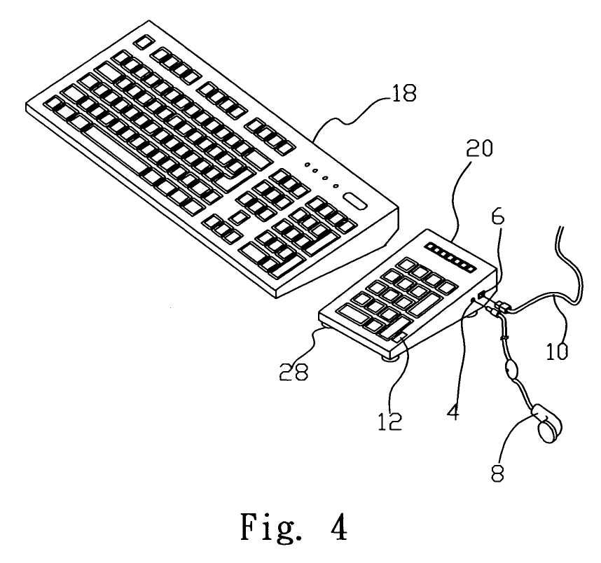

Referring to FIG. 4, a fourth embodiment of the present invention is shown. The keyboard 18 is separated from the phone apparatus 20. The phone apparatus 20 comprises at least one sucking device for fixedly attaching on the desk and positioning beside the keyboard 18, thereby using the keyboard 18 and the phone apparatus 20 simultaneously.

According to the present invention, a phone apparatus combined with keyboard is provided, integrating the keyboard with the phone apparatus. The user can answer the phone and operate the computer at the same time, thereby greatly increasing the working efficiency. The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. An apparatus combined with telephone and keyboard functions, comprising:
a keyboard having a sound transmission device and a phone line socket on one side thereof; and
a phone module in the keyboard for connecting with the phone line socket.

2. The apparatus of claim 1, wherein the sound transmission device comprises a sound transmission socket for connecting with an earphone/microphone.

3. The apparatus of claim 1, wherein the phone line socket is connected with a phone line or a network line.

4. The apparatus of claim 1, wherein the keyboard further comprises a speaker/microphone disposed thereon.

5. The apparatus of claim 1, wherein the keyboard comprises a phone switching key disposed thereon.

6. The apparatus of claim 1, wherein the keyboard comprises a multifunction key module.

7. The apparatus of claim 6, wherein the multifunction key module comprises a plurality of numeral keys and a plurality of function keys including transfer and hold keys.

8. The apparatus of claim 1, wherein the sound transmission device comprises a wireless transceiver.

9. The apparatus of claim 2, wherein a receiving hole is disposed on one side of the keyboard, and one end of the earphone/microphone is fixedly connected to the keyboard though the receiving hole.

10. The apparatus of claim 9, wherein the earphone/microphone apparatus is retractable to be received in the receiving hole.

11. An apparatus combined with telephone and keyboard function, comprising:
a phone apparatus having a sound transmission device and a phone line socket on one side thereof; and
a phone module connected to the phone line socket so that the phone apparatus can be used with a keyboard.

12. The apparatus of claim 11, wherein the sound transmission device comprises a sound transmission socket for connecting with an earphone/microphone.

13. The apparatus of claim 11, wherein the phone apparatus is engaged with the keyboard.

14. The apparatus of claim 11, wherein the phone apparatus and the keyboard are integrated together.

15. The apparatus of claim 11, wherein the phone apparatus comprises at least one sucking device.

16. The apparatus of claim 11, wherein the phone apparatus comprises a multifunction key module.

17. The apparatus of claim 16, wherein the multifunction key module comprises a plurality of numeral keys and a plurality of function keys including transfer and hold keys.

18. The apparatus of claim 11, wherein the sound transmission device comprises a wireless transceiver.

19. The apparatus of claim 12, wherein a receiving hole is disposed on one side of the keyboard, and one end of the earphone/microphone is positioned inside the keyboard passing though the receiving hole.

20. The apparatus of claim 19, wherein the earphone/microphone is retractable to be received in the receiving hole.
